(19) United States
(12) Patent Application Publication
(10) Pub. No.: US 2018/0072838 A1
(43) Pub. Date: Mar. 15, 2018

(54) IMPROVEMENTS RELATING TO POLYOLS AND POLYURETHANES

(71) Applicant: SHELL OIL COMPANY, HOUSTON, TX (US)

(72) Inventors: Pranaya Man Singh PRADHAN, Bangalore (IN); Eswaramurthi NACHIAPPAN, Bangalore (IN); Michiel Barend ELEVELD, Amsterdam (NL)

(21) Appl. No.: 15/564,475

(22) PCT Filed: Apr. 6, 2016
(86) PCT No.: PCT/EP2016/057470

§ 371 Date: Oct. 5, 2017

(30) Foreign Application Priority Data
Apr. 8, 2015 (IN) 1854/CHE/2015

(51) Int. Cl. C08G 18/48; C08G 18/76; C08G 65/26

(52) U.S. Cl. CPC C08G 18/485; C08G 18/4866; C08G 2101/005; C08G 65/2609; C08G 65/2663; C08G 18/7614

(57) ABSTRACT

A polyether polyol containing composite metal cyanide complex catalyst residue, said polyether polyol having a functionality in the range of from 2.9 to 4.5, a hydroxyl value in the range of from 28 to 42 and containing in the range of from 8 to 60 wt % ethylene oxide moieties randomly distributed throughout the polyether chains.

### FIELD OF THE INVENTION

This invention relates to the preparation of polyether polyols and their use in polyurethane foams.

### BACKGROUND TO THE INVENTION

Polyurethane (PU) foams have found extensive use in a multitude of industrial and consumer applications. This popularity is due to their wide-ranging mechanical properties and ability to be easily manufactured.

Polyurethanes are prepared by the reaction of polyisocyanates (e.g. diisocyanates) and polyols. These components are brought together along with a blowing agent, a suitable catalyst and optionally ancillary chemicals under reaction conditions in order to produce the desired foam. In the production of polyurethane different reactions, such as chain extension (growth or gel reactions) and ‘blow’ reactions, occur simultaneously.

In order to produce a polyurethane foam with properties suitable for a particular use, a number of factors must be carefully balanced. The different reactions must proceed simultaneously at optimum balanced rates relative to each other in order to obtain a good foam structure. To achieve this, a suitable catalyst system must be selected. Further, the properties of polyurethane foams depend strongly upon the foaming and polymerizing efficiencies of the polyol which is in turn governed by the structural properties of the initiator, and the structure and properties of the polyether chains.

In order to produce high-resilience (HR) polyurethane foams, polyols containing longer, elastic polyether chains are used. However, longer chains give a lower concentration of hydroxyl groups which can lead to a misbalance of blow versus growth reactions.

When substituted alkylene oxides, such as propylene oxide (PO), are used in the production of polyether polyols, the terminal OH groups on the polyether chains are secondary. Such polyether polyols are, therefore, inherently less reactive than ones that contain terminal primary OH groups. As the gel reaction does not occur quickly enough with the secondary OH groups in comparison to the blow reaction, it is not possible to use such secondary OH group-containing polyether polyols directly in the production of high resilience PU foams. In such a case the PU network is not strong enough at the end of the blow reaction and the foam is liable to collapse.

In the prior art, this problem has been overcome by ‘EO-tipping’ the polyether chains. EO-tipping requires the reaction of a number of equivalents of ethylene oxide (EO) onto the end of the secondary OH group terminated chains. The resultant polyether polyols then have predominantly EO-terminated polyol chains, which provide primary OH groups suitable for use in the production of high resilience PU foams.

In practice, EO-tipping can only be achieved using a KOH-catalysed polyether formation reaction. When using double metal cyanide (DMC) catalysts in this process, the combination of the more active catalyst and the inherent activity of primary OH groups results in long chains of EO on only a few of the polyether chains rather than the EO groups being evenly distributed over all of the polyether chains.

DMC-catalysed production of polyether polyols is faster and more efficient than the traditional KOH catalysed process. The process can also be run on a continuous system, rather than as a batch process, further increasing its efficiencies.

In order to use polyether polyols made in a DMC-catalysed process in the production of HR PU foams, the polyether polyols must be subjected to a separate, batch EO-tipping step catalysed by KOH.

It would, therefore, be advantageous to provide a polyether polyol obtainable by a DMC catalysed process that was suitable for direct use in the production of high resilience PU foam.

### SUMMARY OF THE INVENTION

According to a first aspect of the invention, there is provided a polyether polyol containing composite metal cyanide complex catalyst residue, said polyether polyol having a functionality in the range of from 2.9 to 4.5, a hydroxyl value in the range of from 28 to 42 and containing in the range of from 8 to 60 wt % ethylene oxide moieties randomly distributed throughout the polyether chains.

According to a second aspect of the invention, there is provided a process for the production of polyether polyols comprising reacting one or more hydroxyl-containing starting compounds with a mixture of alkylene oxides in the presence of a composite metal cyanide complex catalyst, wherein the one or more hydroxyl-containing starting materials has an average functionality in the range of from 2.9 to 4.5 and the mixture of alkylene oxides comprises in the range of from 40 to 92 wt % propylene oxide and in the range of from 8 to 60 wt % ethylene oxide.

According to a third aspect of the invention, there is provided a polyurethane foam with a resilience of at least 50%, said polyurethane foam comprising the reaction product of (i) a polyether polyol containing composite metal cyanide complex catalyst residue said polyether polyol having a functionality in the range of from 2.9 to 4.5, a hydroxyl value in the range of from 28 to 42 and containing in the range of from 8 to 60 wt % ethylene oxide moieties randomly distributed throughout the polyether chains; and (ii) foam-forming reactants comprising an aromatic polyisocyanate.

According to a fourth aspect of the invention, there is provided a process for the production of a polyurethane foam, said process comprising reacting (i) a polyether polyol containing composite metal cyanide complex catalyst residue, said polyether polyol having a functionality in the range of from 2.9 to 4.5, a hydroxyl value in the range of from 28 to 42 and containing in the range of from 8 to 60 wt % ethylene oxide moieties randomly distributed throughout the polyether chains; and (ii) an aromatic polyisocyanate in the presence of one or more catalysts having gelling and/or blowing activities.

### DETAILED DESCRIPTION OF THE INVENTION

The present inventors have surprisingly found that a polyether polyol suitable for use in the production of HR polyurethane foams can be made in a DMC-catalysed process by using a hydroxyl-containing starting material with higher than usual average functionality and by incorporating into the polyether chains ethylene oxide moieties at random such that the amount of ethylene oxide, as a weight percentage of the overall amount of alkylene oxides, is in the range of from 8 to 60 wt %

Suitable hydroxyl-containing starting compounds include polyfunctional alcohols, containing from 2 to 8 hydroxyl groups. In the present invention, it is necessary to use a hydroxyl-containing starting compound or mixture of such compounds with a high enough average functionality such that the resultant polyether polyol has a functionality in the range of from 2.9 to 4.5. If suitable, mixtures of hydroxyl-containing starting compounds with higher and lower functionalities may be used in order to obtain the required functionality. Examples of suitable polyfunctional alcohols comprise glycols, glycerol, pentaerythritol, trimethylolpropane, triethanolamine, sorbitol and mannitol. Advantageously, glycerol or a mixture of propylene glycol (MPG) and glycerol is used as starting compound.

The term “functionality” is used herein to refer to the average number of reactive sites per molecule of polyol. The functionality is determined by the number average molecular weight of the polyol divided by the equivalent weight of the polyol. The ‘functionality’ of the hydroxyl-containing starting material is the number of active sites per molecule of each hydroxyl-containing starting compound. If a mixture of hydroxyl-containing starting compounds is used, a molecular average functionality value is calculated.

Preferably, the hydroxyl-containing starting compound or mixture of such compounds has a functionality in the range of from 2.9 to 4.5. When polyether polyols are formed in a DMC-catalysed reaction, little or no functionality is lost between the hydroxyl-containing starting compounds and the product polyether polyols.

The polyether polyol has a functionality of at least 2.9, preferably at least 2.7, more preferably at least 2.8. The functionality of the polyether polyol is at most 4.5, preferably at most 4.0, more preferably at most 3.5.

The term ‘hydroxyl value’ is used herein to refer to the milligrams of potassium hydroxide equivalent to the hydroxyl content in one gram of polyol determined by wet method titration. The inventive polyether polyol has a hydroxyl value in the range of from 28 to 42. Preferably, the hydroxyl value is at least 30, more preferably at least 32. Preferably, the hydroxyl value is at most 40.

The polyether polyol is prepared by ring-opening polymerization of alkylene oxide in the presence of a composite metal cyanide complex catalyst. In the present invention, the alkylene oxide comprises at least 8 wt % ethylene oxide, preferably at least 10 wt % ethylene oxide and at most 60 wt % ethylene oxide, preferably at most 40 wt %, more preferably at most 30 wt % ethylene oxide. The remainder of the alkylene oxide is preferably propylene oxide. Suitably, therefore, the alkylene oxide comprises in the range of from 40 to 92 wt % propylene oxide.

Such a reaction process results in the inventive polyol which contains in the range of from 8 to 60 wt % ethylene oxide moieties randomly distributed throughout the polyether chains.

Composite metal cyanide complex catalysts are frequently also referred to as double metal cyanide (DMC) catalysts. A composite metal cyanide complex catalyst is typically represented by the following formula (1):

M¹ₐ[M²_{b}(CN)_{c}]_{d}.e(M¹_{f}X_{g}).h(H₂0).i(R) (1)

wherein each of M¹ and M² is a metal, X is a halogen atom, R is an organic ligand, and each of a, b, c, d, e, f, g, h and i is a number which is variable depending upon the atomic balances of the metals, the number of organic ligands to be coordinated, etc.

In the above formula (1), M¹ is preferably a metal selected from Zn(II) or Fe(II). In the above formula, M² is preferably a metal selected from Co(III) or Fe(III). However, other metals and oxidation states may also be used, as is known in the art.

In the above formula (1), R is an organic ligand and is preferably at least one compound selected from the group consisting of an alcohol, an ether, a ketone, an ester, an amine and an amide. As such an organic ligand, a water-soluble one may be used. Specifically, one or more compounds selected from tert-butyl alcohol, n-butyl alcohol, iso-butyl alcohol, tert-pentyl alcohol, isopentyl alcohol, N, N-dimethyl acetamide, glyme (ethylene glycol dimethyl ether), diglyrste (diethylene glycol dimethyl ether), triglyme (triethylene glycol dimethyl ether), ethylene glycol mono-tert-butylether, iso-propyl alcohol and dioxane, may be used as organic ligand(s). The dioxane may be 1,4-dioxane or 1,3-dioxane and is preferably 1,4-dioxane. Most preferably, the organic ligand or one of the organic ligands in the composite metal cyanide complex catalyst is tert-butyl alcohol. Further, as an alcohol organic ligand, a polyol, preferably a polyether polyol may be used. More preferably, a poly (propylene glycol) having a number average molecular weight in the range of from 500 to 2,500 Dalton, preferably 800 to 2,200 Dalton, may be used as the organic ligand or one of the organic ligands. Most preferably, such poly(propylene glycol) is used in combination with tert-butyl alcohol as organic ligands. The composite metal cyanide complex catalyst can be produced by known production methods.

In the DMC-catalysed production of polyether polyols, the composite metal cyanide complex catalyst is not removed entirely from the product. The polyether polyol of the invention will, therefore, contain residue of the composite metal cyanide complex catalyst.

The polyether polyol typically has a number average molecular weight in the range of from 3500 to 6000 Daltons.

The process for the production of polyether polyols may be carried out as a batch, a semi-batch or a continuous process. In a batch process, starting materials are added to the reactor, the reactor is allowed to continue to completion and then product is removed from the reactor. In a semi-batch process, reactants are added to the reactor over time as the reaction proceeds. Once all of the reactants have been added, the reaction is allowed to proceed to completion and then product is removed from the reactor. In a continuous process, there is a continuous flow of reactants into the reactor and a simultaneous continuous flow of product out of the reactor as the reaction proceeds. These flows into and out of the reactor are maintained at similar levels in order to prevent a build-up or an emptying of reactants in the reactor. Preferably, the process of the invention is carried out as a semi-batch or continuous process. More preferably, the process is carried out as a continuous process.

The polyether polyol reactor is fed with alkylene oxides, hydroxyl-containing starting materials (initiator) and catalyst (preferably in the form of a slurry in an initiator or an inert component, for example MPG, DPG, glycerine or a hydrocarbon). Each of these feeds may be added to the reactor as separate streams. Alternatively, one or more of the feeds may be mixed together before being supplied to the reactor. In one embodiment, for example, it is suitable to provide the alkylene oxides to the reactor as a mixture of the required amount of ethylene oxide in propylene oxide. The polyurethane foam of the present invention has a resilience of at least 50%, preferably at least 54%. Resilience provides a measure of the surface elasticity of a foam and can relate to comfort or ‘feel’. Resilience is typically measured by dropping a ˜16 g steel ball onto a foam and measuring how high the ball rebounds, this test is typically referred to as “ball rebound test”. Typically, for polyurethane foams, resilience ranges from about 30% up to 70%. There are additional ways of measuring comfort properties of foam for example ratio of foam hardness at 65% height deflection over foam hardness at 25% height deflection, such ratio is sometimes referred to as “SAG factor” or “Comfort factor” and higher the ratio better the comfort properties. For a furniture cushion this means as a person sits on the foam initially the surface of the foam is soft but as the person puts all his/her weight on the cushion foam is able to support the load. Typically ball rebound values are directly proportional to SAG factor, and as “ball rebound test” is easy to perform it is commonly used as method to measure comfort property of foam. Higher resilience in a foam hence often means that the foam, when used for example in cushions, provides better comfort properties.

The polyurethane foam is produced by reacting the polyether polyol with foam-forming reactants comprising an aromatic polyisocyanate. As is known in the art, the foam-forming reactants will typically comprise the aromatic polyisocyanate and at least a blowing agent.

The aromatic polyisocyanate may for example comprise tolylene diisocyanate (TDI), diphenylmethane diisocyanate (MDI) or polymethylene polyphenyl isocyanate.

One or more aliphatic polyisocyanates, such as for example hexamethylene diisocyanate, xylylene diisocyanate, dicyclohexylmethane diisocyanate, lysine diisocyanate or tetramethylxylylene diisocyanate, an alicyclic polyisocyanate such as isophorone diisocyanate, or a modified product thereof may also be present.

In an embodiment, the aromatic polyisocyanate comprises or consists of a mixture of 80% w/w of 2,4-tolylene diisocyanate and 20% w/w of 2,6-tolylene diisocyanate, which mixture is known as “TDI-80”.

In the aspects of the present invention, the molar ratio of isocyanate (NCO) groups in the polyisocyanate to hydroxyl (OH) groups in the polyether polyol and any water may suitably be at most 1/1, which corresponds to a TDI index of 100. In an embodiment, the TDI index is at most 90. Optionally, the TDI index may be at most 85.

The TDI index may suitable be at least 70, in particular at least 75.

The foam-forming reactants may comprise an amount of aromatic polyisocyanate for providing the TDI index. In an embodiment the aromatic polyisocyanate is the sole isocyanate in the foam-forming reactants.

The blowing agent used to prepare the polyurethane foam of the present invention may advantageously comprise water. The use of water as a (chemical) blowing agent is well known. Water reacts with isocyanate groups according to the well-known NCO/H₂O reaction, thereby releasing carbon dioxide which causes the blowing to occur.

However, other suitable blowing agents, such as for example, acetone, gaseous or liquid carbon dioxide, halogenated hydrocarbons, aliphatic alkanes and alicyclic alkanes may be employed additionally or alternatively.

Due to the ozone depleting effect of fully chlorinated, fluorinated alkanes (CFC's) the use of this type of blowing agent is generally not preferred, although it is possible to use them within the scope of the present invention. Halogenated alkanes, wherein at least one hydrogen atom has not been substituted by a halogen atom (the so-called HCFC's) have no or hardly any ozone depleting effect and therefore are the preferred halogenated hydrocarbons to be used in physically blown foams. One suitable HCFC type blowing agent is 1-chloro-1,1-difluoroethane.

It will be understood that the above blowing agents may be used singly or in mixtures of two or more. The amounts in which the blowing agents are to be used are those conventionally applied, i.e.: in the range of from 0.1 to 10 per hundred parts by weight of polyol component (pphp), in particular in the range of from 0.1 to 5 pphp, more in particular in the range of from 0.5 to 3 pphp in case of water; and between about 0.1 and 50 pphp in particular in the range of from 0.1 to 20 pphp, more in particular in the range of from 0.5 to 10 pphp in case of halogenated hydrocarbons, aliphatic alkanes and alicyclic alkanes.

Additionally, other components may also be present during the polyurethane preparation process of the present invention, such as surfactants and/or cross-linking agents.

The use of foam stabilisers (surfactants) is well known. Organosilicone surfactants are most conventionally applied as foam stabilisers in polyurethane production. A large variety of such organosilicone surfactants is commercially available. Usually, such foam stabiliser is used in an amount of from 0.01 to 5.0 parts by weight per hundred parts by weight of polyol component (pphp). Preferred amounts of stabiliser are from 0.25 to 1.0 pphp.

The use of cross-linking agents in the production of polyurethane foams is also well known. Polyfunctional glycol amines are known to be useful for this purpose. The polyfunctional glycol amine which is most frequently used and is also useful in the preparation of the present flexible polyurethane foams, is diethanol amine, often abbreviated as DEOA. If used at all, the cross-linking agent is applied in amounts up to 2 parts by weight per hundred parts by weight of polyol component (pphp), but amounts in the range of from 0.01 to 0.5 pphp are most suitably applied.

In addition, other well-known auxiliaries, such as fillers and flame retardants may also form part of the foam-forming reactants.

Suitably, flame retardant may be present in a “flame retardant effective amount”, i.e. an amount of total flame retardant sufficient to impart flame resistance to the polyurethane foam sufficient to pass a flame resistance standard, e.g. BS 5852, Part 2, Crib 5 or Cal 117 Section A—Part 1.

The total amount of flame retardant may suitably be in the range of from 10 to hundred parts by weight per hundred parts by weight of polyol component (pphp), in particular between about 20 and about 80 pphp.

In an embodiment, melamine or a melamine derivative is used as a principal flame retardant. Suitably, melamine may be employed together with a supplemental flame retardant, e.g. a halogenated phosphate.

The melamine useful in the present invention is suitably employed in an amount of between about 5 and about 50 parts by weight per hundred parts by weight of polyol component (pphp), preferably between about 20 and about 50 pphp in the urethane-forming reaction mixture.

The melamine and/or its derivatives can be used in any form, as may be desired, including solid or liquid form, ground (e.g., ball-milled) or unground, as may be desired for any particular application.

The supplemental flame retardant, such as halogenated phosphate, may suitably be employed in an amount of between about 10 and about 30 pphp, preferably between about 15 and about 25 pphp. An example of a suitable halogenated phosphate flame retardant is tris-mono-chloro-propyl-phosphate (TMCP), commercially available, for example, under the name Antiblaze®.

The reaction to produce the polyurethane foam is carried out in the presence of one or more catalysts having gelling and/or blowing activities.

Polyurethane catalysts are known in the art and include many different compounds and mixtures thereof. Amines and organometallics are generally considered most useful. Suitable organometallic catalysts include tin-, lead- or titanium-based catalysts, preferably tin-based catalysts, such as tin salts and dialkyl tin salts of carboxylic acids. Specific examples are stannous octoate, stannous oleate, dibutyltin dilaureate, dibutyltin acetate and dibutyltin diacetate. Suitable amine catalysts are tertiary amines, such as, for instance, bis (2,2′-dimethylamino) ethyl ether, trimethylamine, triethylamine, triethylenediamine and dimethylethanol-amine (DMEA). Examples of commercially available tertiary amine catalysts are those sold under the tradenames NIAX, TEGOAMIN and DABCO (all trademarks). The catalyst is typically used in an amount of from 0.01 to 2.0 parts by weight per hundred parts by weight of polyether polyol (php). Preferred amounts of catalyst are from 0.05 to 1.0 php.

In general, the process or use of the invention may involve combining the polyol component, the foam-forming reactants and the one or more catalyst in any suitable manner to obtain the polyurethane foam.

In an embodiment, the process comprises stirring the polyol component, the foam-forming reactants (except the polyisocyanate) and the one or more catalyst together for a period of at least 1 minute; and adding the polyisocyanate under stirring.

In an embodiment, the full rise time (FRT, measured as the time from start of aromatic isocyanate addition/mixing to end of foam rise) is no greater than 360 seconds, in particular no greater than 250 seconds, such as no greater than 240 seconds.

In an embodiment, the process comprises forming the foam into a shaped article before it fully sets. Suitably, forming the foam may comprise pouring the polyol component, the foam-forming reactants and the one or more catalyst into a mould before gelling is complete.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property then a range of values defined by a combination of any of the upper limits with any of the lower limits may also be implied.

In this specification, references to component properties are—unless stated otherwise—to properties measured under ambient conditions, ie at atmospheric pressure and at a temperature of about 23° C.

The present invention will now be further described with reference to the following non-limiting examples.

### EXAMPLES

### Polyols

The following materials were used as starting materials in the production of polyols:
Intermediate diol: a water/PO adduct with a molecular weight of 400 and OH-value of 260
Intermediate triol: a glycerine/PO adduct with a molecular weight of 670 and an OH-value of 250
DMC catalyst: ARCOL-3 catalyst from Bayer Material Science
Catalyst suspension: 3% of DMC catalyst in intermediate diol

### Polyol Example 1 (10.3% EO; Hydroxyl Value=37

A mixture of intermediate triol (600.89 g) and catalyst suspension (3.333 gr) was stripped for one hour with nitrogen purge at 130° C. Then some PO (92 gr) was added until a pressure drop is observed, indicating activation of the catalyst. Subsequently, a mixture of PO (2907.1 g) and EO (400 g) was added over 3 hours. The mixture was left for another half hour at 130° C., then stripped for 60 min with a nitrogen purge at 130° C. and cooled down to 100° C. Subsequently, Irganox 1135 (4.00 g) and Irganox 5057 (8.40 g) were added and the mixture was stirred for 1 hr at 100° C. In total approximately 4.0 kg product with the following properties was obtained. Functionality (measured): 2.992

### Viscosity: 391 cSt (40 C)

### OH-value: 37.3

### EO-content: 10.3%

pHc: 11.8%

### Polyol Example 2 (16.8% EO; Hydroxyl Value=36)

A mixture of intermediate triol (600.89 g) and catalyst suspension (3.333 g) was stripped for one hour with nitrogen purge at 130° C. PO (92 g) was added until a pressure drop was observed, indicating activation of the catalyst. Subsequently, a mixture of PO (2507.1 g) and EO (800 g) was added over 3 hours. The mixture was left for another half hour at 130° C. and then stripped for 60 min with a nitrogen purge at 130° C. before being cooled down to 100° C. Subsequently, Irganox 1135 (4.00 g) and Irganox 5057 (8.40 g) were added and the mixture was stirred for 1 hr at 100° C. In total approximately 4.0 kg of product having the below properties was obtained:

Functionality (measured): 2.992

### Viscosity: 391 cSt (40° C.)

### OH-value: 36.9

### EO-content: 19.6%

pHc: 16.8%

### Polyurethane Foams

As a reference polyol, Caradol SC48-08 (OH-value=48; EO-content=10.5%; Functionality: 2.8) was used. The reference polyol and the polyols made in Examples 1 and 2 were used to make polyurethane foams according to standard processes, as set out in Tables 1 to 3.

TABLE 1
PU-foams with 32-26 kg/m³ density were made.

| | | | Polyol | Polyol |
|---|---|---|---|---|
| | | Ref polyol | Example 1 | Example 2 |
| polyol | pbw | 100 | 100 | 100 |
| water | php | 2.7 | 2.7 | 2.7 |
| 33LV/A1 2:1 | php | 0.17 | 0.16 | 0.16 |
| B4900 | php | 0.6 | 0.6 | 0.4 |
| T-9 | php | 0.19 | 0.19 | 0.16 |
| TDI index | | 107 | 107 | 107 |
| TDI | php | 35.9 | 34.1 | 34.1 |
| start of rise | sec | 17 | 18 | 18 |
| FRT/blow-off | sec | 118 | 127 | 124 |
| gel time | sec | 173 | 190 | 206 |
| Density | kg/m³ | 31.6 | 34.3 | 35.6 |
| Resilience | % | 43 | 49 | 52 |
| CLD 5% | kPa | 2.2 | 2.3 | 2.2 |
| CLD 40% | kPa | 3.3 | 3.6 | 3.8 |

TABLE 2
PU-foams with 48-52 kg/m³ density and index 107

| | | | Polyol | Polyol |
|---|---|---|---|---|
| | | Ref polyol | Example 1 | Example 2 |
| polyol | pbw | 100 | 100 | 100 |
| water | php | 1.6 | 1.6 | 1.6 |
| 33LV/A1 2:1 | php | 0.2 | 0.18 | 0.26 |
| B4900 | php | 0.6 | 0.6 | 0.5 |
| T-9 | php | 0.14 | 0.14 | 0.12 |
| TDI index | | 107 | 107 | 107 |
| TDI | php | 24.5 | 22.7 | 22.7 |
| start of rise | sec | 22 | | 20 |
| FRT/blow-off | sec | 296 | | 295 |
| gel time | sec | 345 | | 411 |
| Density | kg/m3 | 47.4 | 50.2 | 51.3 |
| Resilience | % | 36 | 51 | 45 |
| CLD 5% | kPa | 1.9 | 2.1 | 2 |
| CLD 40% | kPa | 3.3 | 3.9 | 3.8 |

TABLE 3
PU-foams with 48-52 kg/m³ density and index 110

| | | | | Polyol |
|---|---|---|---|---|
| | | Ref polyol | Ref polyol | sample 1 |
| polyol | pbw | 100 | 100 | 100 |
| water | php | 1.6 | 1.6 | 1.6 |
| 33LV/A1 2:1 | php | 0.25 | 0.3 | 0.2 |
| B4900 | php | 0.6 | 0.6 | 0.6 |
| T-9 | php | 0.11 | 0.11 | 0.12 |
| TDI index | | 110 | 110 | 110 |
| TDI | php | 25.2 | 25.2 | 23.3 |
| start of rise | sec | 20 | 19 | 20 |
| FRT/blow-off | sec | 318 | 229 | 337 |
| gel time | sec | 382 | 288 | 485 |
| Density | kg/m3 | 48.4 | 45.2 | 49.9 |
| Resilience | % | 50 | 46 | 57 |
| CLD 5% | kPa | 1.9 | 2.2 | 2.2 |
| CLD 40% | kPa | 3.3 | 3.5 | 3.8 |

The examples clearly demonstrate an improved resilience when the reference polyol is replaced by polyols according to the invention.

1. A polyether polyol containing composite metal cyanide complex catalyst residue, said polyether polyol having a functionality in the range of from 2.9 to 4.5, a hydroxyl value in the range of from 28 to 42 and containing in the range of from 8 to 60 wt % ethylene oxide moieties randomly distributed throughout the polyether chains.

2. The polyether polyol according to claim 1, wherein, the functionality is in the range of from 2.8 to 3.5.

3. The polyether polyol according to claim 1, wherein said polyether polyol contains in the range of from 10 to 40 wt % ethylene oxide moieties randomly distributed throughout the polyether chains.

4. A process for the production of polyether polyols comprising reacting one or more hydroxyl-containing starting compounds with a mixture of alkylene oxides in the presence of a composite metal cyanide complex catalyst, wherein the one or more hydroxyl-containing starting materials has an average functionality in the range of from 2.9 to 4.5 and the mixture of alkylene oxides comprises in the range of from 40 to 92 wt % propylene oxide and in the range of from 8 to 60 wt % ethylene oxide.

5. The process according to claim 4, wherein the hydroxyl-containing starting material is a mixture of monopropylene glycol and glycerol.

6. A polyurethane foam with a resilience of at least 50%, said polyurethane foam comprising the reaction product of (i) a polyether polyol containing composite metal cyanide complex catalyst residue said polyether polyol having a functionality in the range of from 2.9 to 4.5, a hydroxyl value in the range of from 28 to 42 and containing in the range of from 8 to 60 wt % ethylene oxide moieties randomly distributed throughout the polyether chains; and (ii) foam-forming reactants comprising an aromatic polyisocyanate.

7. The polyurethane foam according to claim 6, wherein said polyurethane foam has a resilience of at least 54%.

8. A process for the production of a polyurethane foam, said process comprising reacting (i) a polyether polyol containing composite metal cyanide complex catalyst residue, said polyether polyol having a functionality in the range of from 2.9 to 4.5, a hydroxyl value in the range of from 28 to 42 and containing in the range of from 8 to 60 wt % ethylene oxide moieties randomly distributed throughout the polyether chains; and (ii) an aromatic polyisocyanate in the presence of one or more catalysts having gelling and/or blowing activities.

9. The process according to claim 8, wherein the functionality of the polyether polyol is in the range of from 2.8 to 3.5.

10. The process according to claim 8, wherein the polyether polyol contains in the range of from 10 to 40 wt % ethylene oxide moieties randomly distributed throughout the polyether chains.
